(19) United States
(12) Patent Application Publication
(10) Pub. No.: US 2002/0129047 A1
(43) Pub. Date: Sep. 12, 2002

(54) Multiple copy capability for network backup systems

(76) Inventors: David A. Cane, Cambridge, MA (US); Lev Vaitzblit, Concord, MA (US); Jonathan F. Freidin, Marblehead, MA (US); Philip A. Speare, Arlington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/735,763

(22) Filed: Dec. 13, 2000

Related U.S. Application Data
(60) Provisional application No. 60/170,341, filed on Dec. 13, 1999.

(51) Int. Cl. G06F 17/30

(52) U.S. Cl. 707/204; 707/10

(57) ABSTRACT

A method and apparatus for providing a multiple copy file backup system is disclosed in which files that have been previously backed up by a first user are to be backed up by different users. The first instance of backing up a file results in storing the file in a first location and associating the file and user in an entry in 238808-1a file data table. For other users needing to backup the same file, the contents of the file are copied from the first location into a second location within the file backup storage system. The file backup system creates two new entries in the file data table. In one entry the file stored in the second location is associated with a User-Pool that allows sharing the file contents among the users. The second and subsequent entries in the file data table will be created as subsequent users desiring desire to backup the file. These entries will indicate that the file is provided by the User-Pool and the necessary data will be copied from the User-Pool entry to properly associate the user with the file contents.

### CROSS REFERENCE TO RELATED APPLICATIONS

This application claims priority under 35 U.S.C. §119(e) to provisional patent application serial No. 60/170,341 filed Dec. 13, 1999; the disclosure of which is incorporated by reference.

### STATEMENT REGARDING FEDERALLY SPONSORED RESEARCH OR DEVELOPMENT

N/A

### BACKGROUND OF THE INVENTION

This application relates generally to file backup systems, and more particularly to file backup systems in a client-server system having a multiple copy capability.

Client-server network systems are well known and widely used in many industries and applications. In a typical client-server system, users operating a client machine send data to one or more central computers-the server-for processing. The processed data may be stored centrally on the server or returned to the client for local storage. In either case, a failure of the primary data storage system whether on the client or the server, can result in a catastrophic loss of the user's data. To prevent this loss of data due to the failure of the primary data storage system, a file backup system is commonly used to allow the recovery of the client data.

The backup system for a client-server system typically maintains an extra copy of the user's data on the server. The backup system typically maintains this extra copy of the user's data on another storage device such as a serial tape device that is less expensive than the hard drives used on the client and server systems.

In a client-server system more than one user may attempt to backup a particular data file. If left unchecked, the backup system could be overwhelmed by the repeated backup of a single data file. Previously, backup systems have been developed that require only the first user to transmit a specific data file to the server for storage on the backup system. These systems detect whenever a subsequent user attempts to backup an identical data file and do not require the second user to transmit the data file and do not store the user's data file repeated times.

A problem arises however, if a user has been on the system for a period of months or years and now has references to shared backup data files that may located in many physical locations throughout the system. Some physical storage systems, such as a tape system, allow only sequential access to the data contained therein. As discussed above, backup systems that support a large number of users typically migrate backup data from their high-speed, random-access disk storage systems to an automated tape library (ATL) located at the server. An ATL provides a very low cost per unit of storage and may also require less floor space, also reducing cost. ATL's do, however, have a longer time associated with recovering data from a tape. In particular, while the data for a particular user may be logically grouped so that it is only on one tape, the references to shared files from other users may be contained on many other physically separate tapes. Each tape would need to be separately read from to retrieve the files and the data contained therein. In addition, an ATL system can be considered unreliable since the probability of losing a tape over the life time of the system is high.

Additionally, if a user's account is cancelled, the present backup systems typically do not allow the space used by the cancelled account to be reclaimed, since removing the files of the cancelled account may result in the loss of shared data. To avoid the indiscriminate loss of shared data, each file must be checked to see if it is shared among other users in what is a time consuming and laborious task.

It would therefore be desirable to be able to back up files in such a way that only a small number of tapes need to be read and that the data can be easily retrieved from. It would also be desirable to allow a file backup system retrieve storage space when an account is cancelled in a more time efficient manner.

### BRIEF SUMMARY OF THE INVENTION

A method and apparatus for providing a multiple copy file backup system is disclosed in which files that have been previously backed up by a first user are to be backed up by different users. The first instance of backing up a file results in storing the file in a first location and associating the file and user in an entry in a file data table. For other users needing to backup the same file, the contents of the file are copied from the first location into a second location within the file backup storage system. The file backup system creates two new entries in the file data table. In one entry the file stored in the second location is associated with a User-Pool that allows sharing the file contents among the users. The second and subsequent entries in the file data table will be created as subsequent users desiring desire to backup the file. These entries will indicate that the file is provided by the User-Pool and the necessary data will be copied from the User-Pool entry to properly associate the user with the file contents.

A method and apparatus for providing a multiple copy file backup system is disclosed in which files that are to be backed up by different users are copied into a second location within the file backup storage system and associated with a User-Pool that allows sharing the file contents among the users.

In one embodiment a file data table is created by a backup file system coupled to a server in a client-server system. A user of a client machine coupled to the server requests to backup a file, the server searches the file data table for any entries that contain as the File ID field the file identifier provided by the user. If no entry is found, the backup file system requests the contents of the file from the client machine and stores the contents of the file at a first location. A new entry in the file data table is created and a User-ID field in the new entry in the file data table is set to the user identifier of the user, a File-ID field in the new entry in the file data table is set to the file identifier, a Sourced By field in the new entry in the file data table is set to the user identifier, a File Location pointer field in the new entry in the file data table is set to the first location, and a Share Count field in the new entry in the file data table is set to zero.

If one entry in the file data table is found, the contents of the file at the first location are copied to a second location and two new entries in the file data table are created. In one of the two new entries that associates the newly copied file with a User-Pool identifier, the User-ID field in the new entry in the file data table is set to the user identifier of the User-Pool, the File-ID field in the new entry in the file data table is set to the file identifier, the Sourced By field in the new entry in the file data table is set to the User-Pool, the File Location pointer field in the new entry in the file data table is set to the second location, and the Share Count field in the new entry in the file data table is set to one.

As discussed above, the server creates two new entries in the file data table. The second new entry created by the server will include the User-ID field in the new entry in the file data table is set to the user identifier of the user, the File-ID field in the new entry in the file data table is set to the file identifier, the Sourced By field in the new entry in the file data table is set to the User-Pool, the File Location pointer field in the new entry in the file data table is set to the second location, and the Share Count field in the new entry in the file data table is set to zero.

If two or more entries in the file data table are located, the entry associating the file identifier with the User-Pool is located from among the entries. The server creates a new entry in the file data table. In the new entry the User-ID field in the new entry in the file data table is set to the user identifier of the user, the File-ID field in the new entry in the file data table is set to the file identifier, the Sourced By field in the new entry in the file data table is set to the User-Pool, the File Location pointer field in the new entry in the file data table is set to the second location as read from the User-Pool entry associated with the file identifier, and the Share Count field in the new entry in the file data table is set to zero. The Share Count field in the entry associating the file identifier with the User-Pool is incremented by one.

### BRIEF DESCRIPTION OF THE SEVERAL VIEWS OF THE DRAWING

The invention will be more fully understood by reference to the following Detailed Description of the Invention in conjunction with the Drawing of which:

FIGS. 1A-1D are a flow chart illustrating a method of storing more than one copy of a file on a file backup system in accordance with the present invention;

FIG. 2 is a block diagram of the present invention;

FIG. 3 is a schematic representation of a file data table in accordance with the present invention; and

FIG. 4 is a schematic representation of the file data table and the file backup storage device in accordance with the present invention.

### DETAILED DESCRIPTION OF THE INVENTION

A method and system in accordance with the present invention for maintaining multiple backup copies on a backup system is disclosed. Typically, the present method and apparatus are part of a client-server system in which users operating a client machine send and receive data from a server. The server maintains backup copies of the user's data on a storage system which may be contained within the server or contained within a separate backup system coupled to the server.

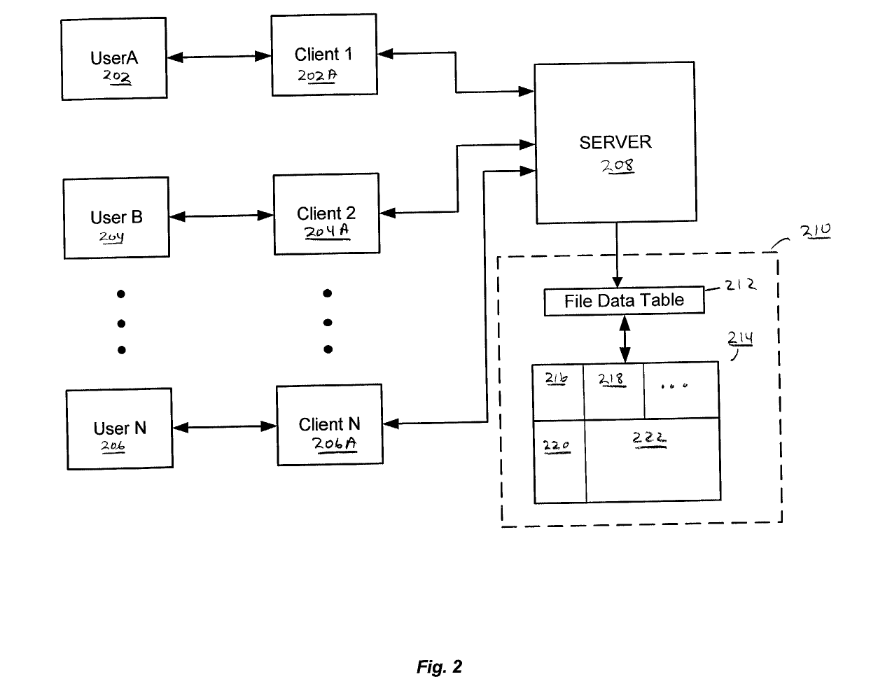

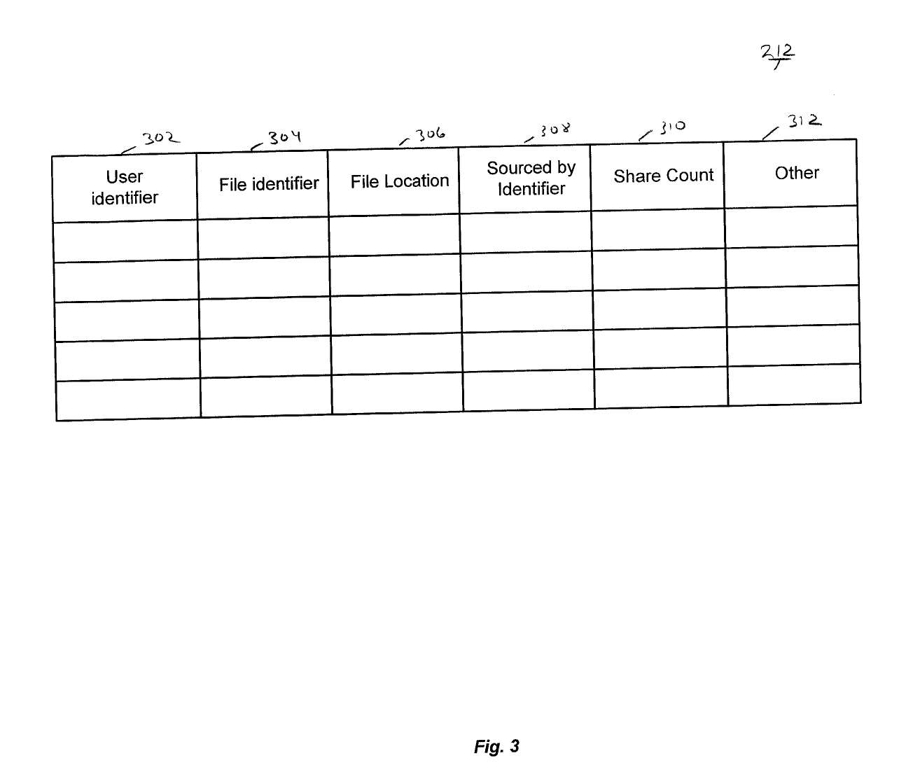

FIGS. 2 and 3 illustrates a system operative to perform multiple copy backup file storage in accordance with the present invention. A plurality of users, User-A 202, User-B 204, to User-N 206 operate a plurality of client machines 202A, 202B and 202N respectively. The client machines 202A, 202B and 202N are coupled to a server 206 that provides data processing and at least some data storage. A backup system 210 that comprises a file data table 212 and a file backup storage system 214 is illustrated as being coupled to the server 206. However, the backup system 210, or a part of the backup system 210 such as the file data table 212, may also be included within the server 204 as well. For example, the file data table 212 may be stored on the storage system within the server and the file backup storage system may be a separate storage system or a storage system on another server (not shown) or a client machine(not shown). The file backup storage system 214 may be a sequential accessible tape or other automated tape library (ATL) system, a random access hard-drive, read/writeable CD, a non-volatile electronic memory such as a Flash-RAM or other non-volatile RAM, or any other storage media that allows the storage and accessing of data.

FIG. 3 illustrates one embodiment of the File Data Table 212. The File Data Table can include a plurality of data associated with each file that is stored in the file backup storage system by the user. In the illustrated embodiment, the file data table 300 includes a User-ID field 302 indicative of the user storing the file in the backup system and a File-ID field 304 of the file being stored. Both the User-ID and the File ID fields should contain unique user and file identifiers respectively to prevent confusion and a loss of data. In addition, the file data table 300 can include a File Location pointer field 306 that points to the location of the contents of the stored file within the backup system, which may be a logical pointer or a physical pointer depending on the type of system used. The file data table further includes a Sourced By field 308 that includes the user identifier of the user providing the copy of the file. The file data table 300 can also contain a Share Count field 310 that indicates the number of users that may share the file copy and a other data considered pertinent by the user may be stored in an Other data field 312. It should be understood that the file data table 212 could be any form of a data structure that would allow data to be stored and accessed. For example, the file data table may be, without limitation, an array of data structures, a matrix, or a linked list.

Referring again to FIG. 2, the server 206, using the file data table 212, maintains the associations between particular users and the files backed up by those users. This is illustrated schematically in FIG. 2 in that the file backup storage system 214 is divided into a plurality of areas corresponding to the plurality of users. For example, area 216 contains the files backed up by User-A, area 218 contains the files backed up by User-B, and area 220 contains the files backed up by User-N. The groupings of the files within these areas is for schematic purposes only, and does not imply that the files are actually located within the same physical area of the file backup storage system 214. Rather the files are logically associated with each user through the file data table 212.

In the first instance of each file being backed up by a first user, the contents of the file will be stored at a first location and a new entry created in the file data table 212. The server will set the user-ID field and the Sourced By field of the file data table 212 to the unique user identifier of the user performing the operation, and the server will set the File ID field will to the unique file identifier associated with the file to be backed up. In addition, the File Location pointer field will be set to the first location, which may be a physical location or a logical association within the storage system, at which the contents of the file are stored, and the Share Count field will be set to zero (0) indicating that no other files share this data.

In the event that another user requests to make a backup copy of a file previously backed up by a first user, the server will make a second copy of the file contents and store the second copy at a second location within the file backup storage system 214. The server associates the second copy of the file contents with a User-Pool of files. The User-Pool contains the second copy of any file that has been backed up more than once by more than one user. Other users that wish to back up a copy of a file, that has been previously backed up, may access the file within the User-Pool.

For each file stored in the file backup storage system and associated with the User-Pool there will be at least two entries created in the file data table 212. One entry, created when the file is placed in the User-Pool, will set the User-ID field to the unique User-Pool identifier, the File-ID field to the unique file identifier, and the Sourced By field to the unique User-Pool identifier. In addition, the server will set the File Location pointer field to point to the file contents stored at the second location within the file backup storage system 214, and the Share Count field will be set to one (1) for the second user needing to backup the file and incremented for each subsequent user thereafter.

The second entry in the file data table 212 will associate the second user needing to backup the file with the previously backed up file. In this entry, the server will set the User-ID field to the unique user identifier of the user requesting to back up the file, set the File-ID field to the unique file identifier associated with the file to be backed up, and set the Sourced By field to the unique User-Pool identifier. In addition, the server will set the File Location pointer field -to point to the file contents stored at the second location within the file backup storage system 214, and the Share Count will be set to zero (0). For each subsequent user that needs to backup the previously backed up file, a new entry will be created in the file data table 212 associating the user with the copy of the file stored in the User-Pool area as described above.

Depending on the availability of system resources, the server may select another time in the future to actually create and store the second copy of the file being backed up. In this case, the File Location pointer field in the User Pool entry in the file data table will be set to point to the first location at which the file is stored. Each of the files to be backed up at a second location can be placed in a queue that is then accessed at the selected time. In addition, the order that the files in the queue are accessed may be manipulated to allow for more efficient storage on the backup storage system. For example it may be more efficient to store certain files physically close to one another on a tape in an ATL.

In the event that a user's account is to be cancelled and the files that the user backed up removed, the server will search the entries in the file data table 212 for each entry in which the User ID field and the Sourced By field are both set to the unique user identifier of the user whose account is to be cancelled. The server then instructs the file backup storage system to delete the contents of the files pointed to by the File Location pointer fields of the respective entries. In this way, each of the files that are unique to that user are removed, but files that are shared by other users are not removed. The server searches the entries in the file data table 212 for any entry having a User ID filed set to the unique user identifier of the user whose account is being removed and the Sourced By field is set to the User Pool identifier and deletes those entries in the file data table. In this way, all entries associated with the desired user are removed from the file data table 212 but entries associated with other users sharing the data are not. In addition, the server decrements the Share Count field in the User Pool entries in which the user being removed shared data. Once the Share Count field has been decremented, the server may determine if the Share Count is now zero, and if so, the server may delete the file pointed to in the File Location pointer field, and the entry in the file data table.

As discussed above, the present invention may be used with many different file backup systems and storage systems. As discussed above, a file tape back up system may not be considered reliable over the lifetime of the system because the probability of losing at least one tape is very high. Making a copy of the file data contained in the User Pool will increase the robustness of the overall system by preventing a single point failure from destroying the only copy of the backed up data. This extra copy of the User Pool file data may be made and stored in a third location that is physically separate from the first and second copies, such as a separate tape or another hard drive. This extra copy of the User Pool data should be stored at a Location that is the same logical location as the original User Pool data, but at a separate location or system, so that the File Location pointer fields in the User Pool entries in the file data table will point to the extra copy of the data when necessary.

In another embodiment, multiple tables may be used to store the file data and the User Pool data separately to facilitate maintenance of each table and the files contained within and also to save on storage space within each table. For example, the file data table in which each user is associated with the files backed up by that user will not contain a Share Count field. In addition, a Sourced By field may not be necessary in the file data table as well, since each user will source those files to itself.

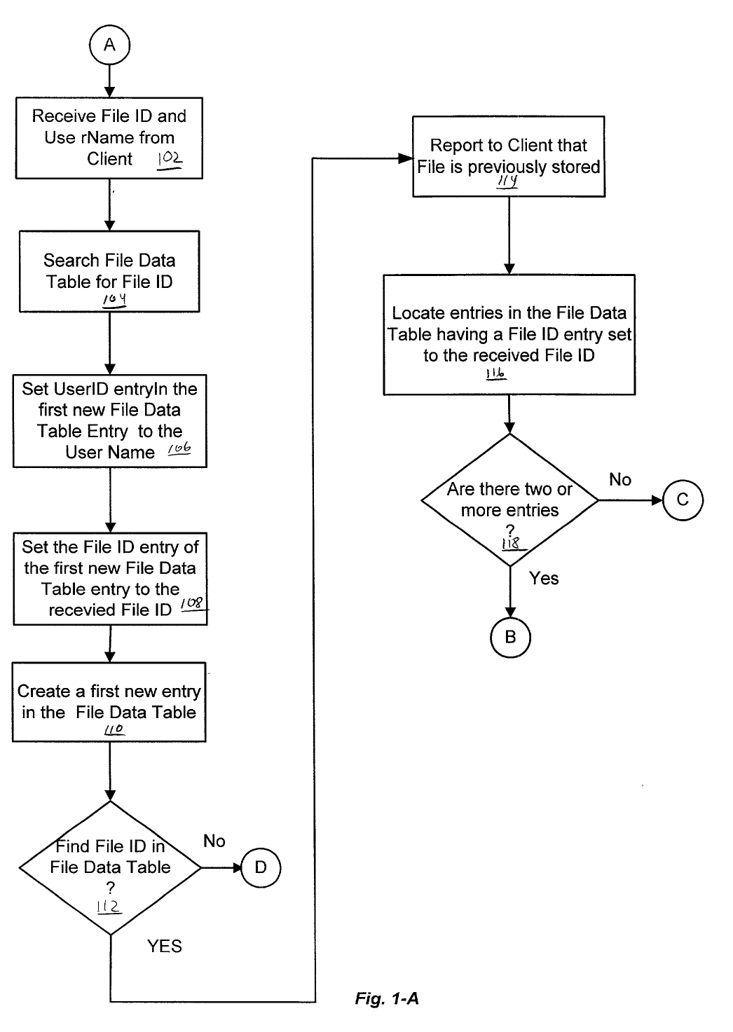

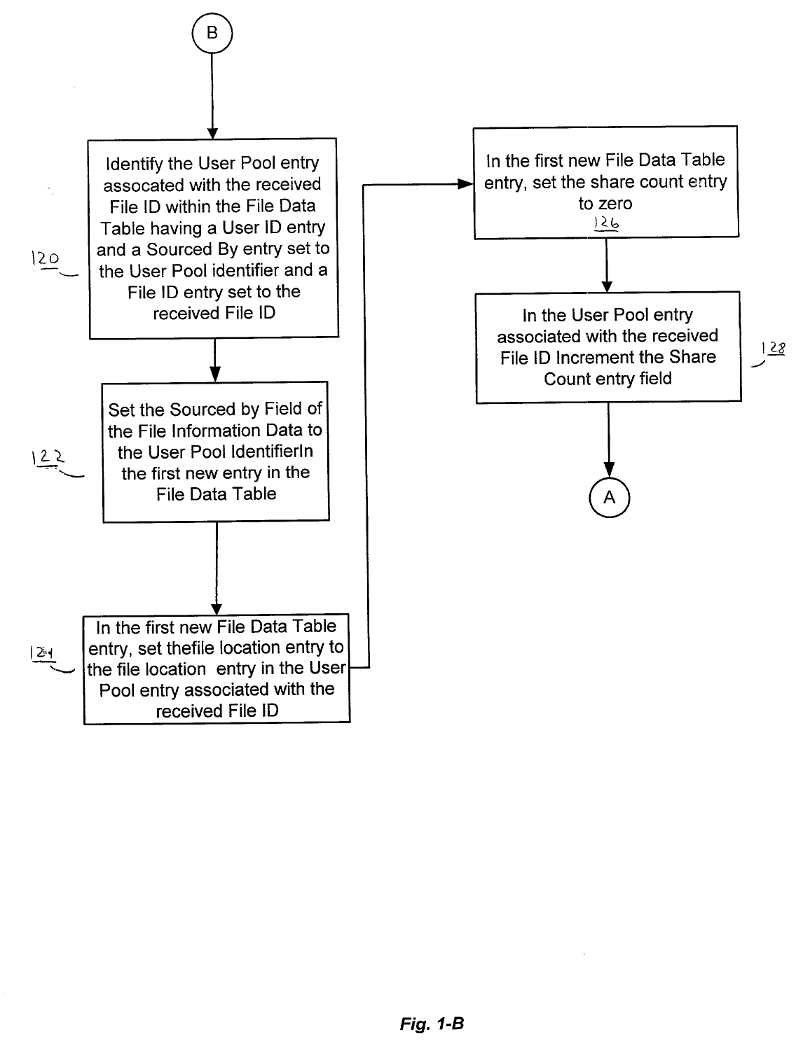

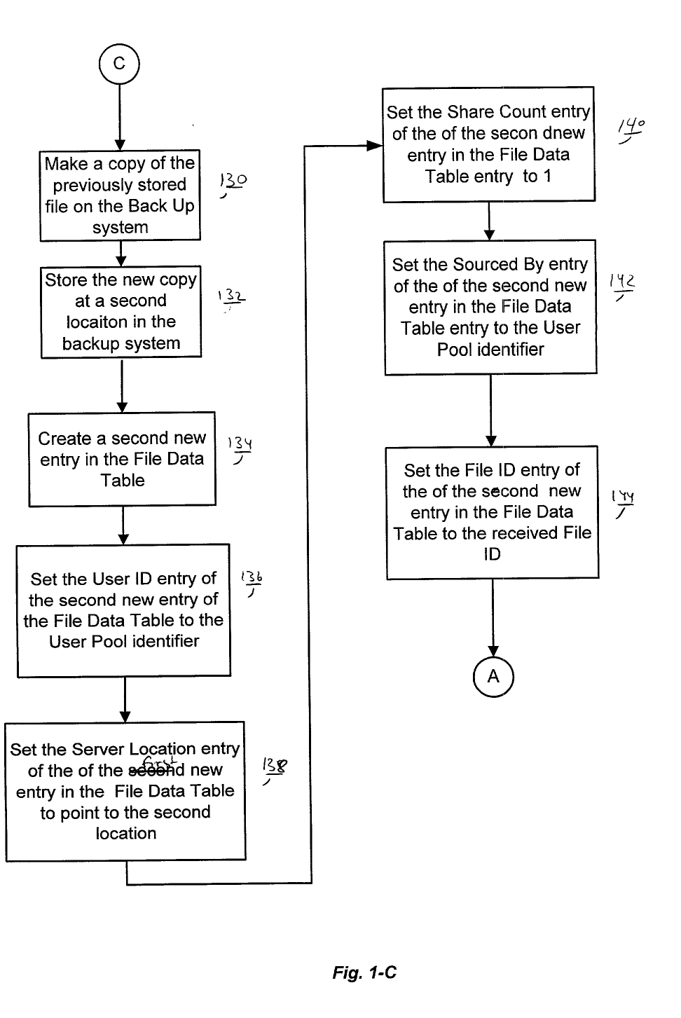

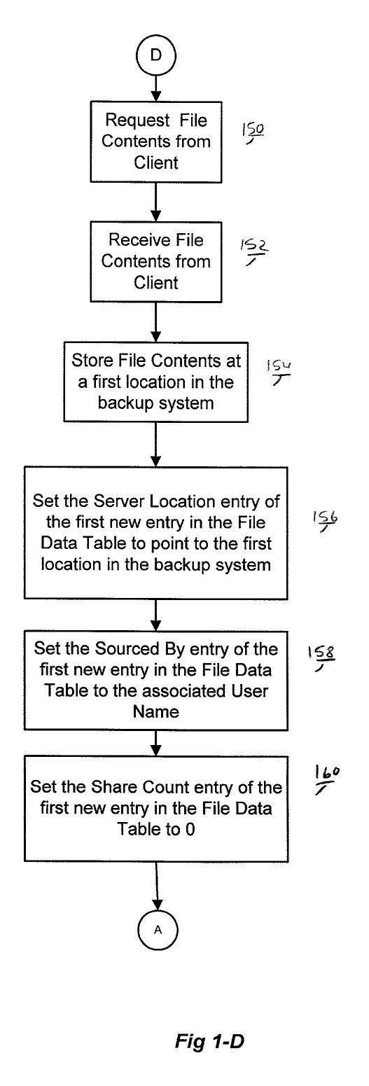

The operation of the presently described multiple copy backup system is described below with respect to the flow diagrams illustrated in FIGS. 1A-1D. As depicted in FIG. 1A, the server receives a unique user identifier of a user desiring to backup a the contents of a file identified by a unique file identifier also provided by the client machine, as illustrated in step 102. The server creates a first new entry in the file data table, as illustrated in step 104, and sets the User ID field to the unique user name provided by the client machine and the File ID field to the unique file ID also provided by the client machine, as illustrated in steps 104, 106, and 108 respectively. The server searches the file data table for the file identifier, as illustrated in step 110. If the file identifier is not located within the file data table, control is passed to step 150, as illustrated in step 112. If the file identifier is located within the file data table, the server reports to the client that the file has been previously stored on the backup system, as illustrated in step 114. The server determines if there are two or more entries in the file data table having a File-ID field set to the unique file identifier received from the client machine, as illustrated in step 116. If there are not two or more entries in the file data table 212 having the File-ID field set to the unique file identifier received from the client machine, control passes to step 130. If there are two or more entries in the file data table 212 having the File-ID field set to the unique file identifier received from the client machine, control passes to step 120.

If one copy of the file exists on the backup system then the server copies the file currently stored on the backup system, as illustrated in step 130 and stores the new copy of the file contents at a second location within the file backup storage system 214, as illustrated in step 132. The server 206 sets the User-ID field identifier to the received unique User-Pool identifier, as illustrated in step 136 and further sets the File Location pointer field to point to the contents of the file stored at the second location, as illustrated in step 138. In addition, the server sets the Share Count field to one (1), the Sourced By field to the unique User-Pool identifier, and the File-ID field to the unique file identifier received from the client machine, as illustrated in steps 140, 142, and 144 respectively.

The server then sets the remaining fields in the first new entry in the file data table 212 previously created in step 104. The server sets the Sourced By field of the first new entry to the unique User-Pool identifier, the File Location pointer field is set to point to the contents of the file stored at the second location, and the Share Count field is set to zero (0). Control is then returned to step 102.

As discussed above, because it may not be the most efficient user of the processor and storage resources of the server to immediately store the second copy of the file, the server may place the file identifiers into a queue to be saved at a later time. Therefore, in another embodiment, when the User Pool entry is made in the file data table, initially the File Location pointer field will point to the first location of the file. The file identifier is placed into a queue and accessed at a later time for storage at the second location. Only after the file is saved in the second location will the File Location pointer field in the User Pool entry and the first new entry be set to the second location at which the file is saved.

If at step 118 there are two or more entries in the file data table in which the File-ID field is set to the unique file identifier received from the client, control passes to step 120. The server identifies the User-Pool entry in the file data table associated with the unique file identifier as illustrated in step 120. The server then sets the remaining fields in the first new entry in the file data table 212. The server sets Sourced By field to the unique User-Pool identifier, as illustrated in step 122. The server then sets File Location pointer field to the value stored in the File Location pointer field of the User-Pool Identified field identified in step 120, as illustrated in step 124. In this way the new entry in the file data table will point to the file contents located at the second location that is associated with the User-Pool. The server then sets the Share Count field in the first new entry to zero (0), as illustrated in step 126. In addition, the server increments the Share Count field in the User-Pool entry identified in step 120, as illustrated in step 128. Control is then returned to step 102.

If at step 106, the received file identifier is not located within the file data table entries, control passes to step 150 as described above. As illustrated in step 150, the server requests the client machine to transmit the contents of the file to the server. The server receives the file contents, as illustrated in step 152, stores the file contents at a first location on the file backup storage system 214 as illustrated in step 154. The server sets the File Location pointer field of the first new entry in the file data table to the point to the file contents located at the first location, as illustrated in step 156. As illustrated in step 158, the server sets the Sourced By field to the unique user identifier received from the client in step 102. As illustrated in step 160, the server sets the share count filed of the first new entry in the file data table to zero (0). Control is then returned to step 102.

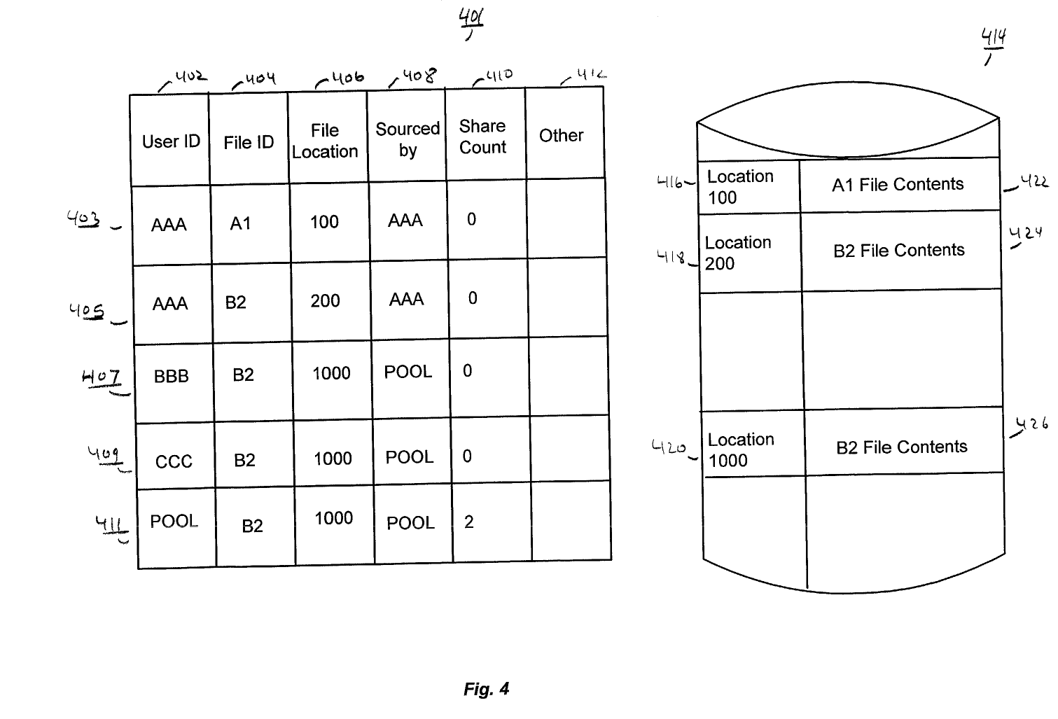

An exemplary illustration of the relationship between the file data table and the stored files in the backup system is illustrated in FIG. 4. An exemplary file data table 401 is provided in which the User-ID is provided in field 402, the File-ID is provided in field 404, the File Location pointer is provided in field 406, the Sourced By identifier is provided in field 408, and the Share Count is provided in field 410. An extra field 411 is provided for other data. An exemplary disk storage system 412 is provided in which the file contents are stored for various files at unique file server locations. In the illustrated examples the various data are purely exemplary and are not meant in any way to be limiting.

Entry 403 in the file data table 401 includes a User-ID AAA, a File-ID A1, a File Location pointer 100 and a Share Count of zero. Because this was the first instance of saving file A1, the Sourced By identifier field is set to the user identifier AAA. The corresponding entry in the disk storage system is entry 416 in which the contents of the file A1 are stored at file server location 100. Entry 405 in the file data table 401 and the corresponding entry 421 similarly identify the file B2 as belonging to user AAA with the contents of the file are stored at file server location 200.

Entry 407 in the file data table 401 includes a user identifier BBB that has also needed to backup file B2 a second time. In this instance, the contents of the file B2 have been copied to the backup storage system a second time and stored at location 1000. In this instance two entries have been made in the file data table. The first entry is entry 407 in which the User-ID field and the File-ID field are set. The User-Pool entry is created and the data set to enable the proper data to be provided to entry 407.

The entry 411 is created that associates the file B2. The entry 411 includes the User-ID filed set to the unique User-Pool identifier, the File-ID is set to the unique file identifier, the File Location pointer field is set to 1000, the second location at which the contents of the file are stored, the Sourced By field is set to the unique User-Pool identifier, and the Share Count field is set to one (1). The corresponding entry in the backup storage system 412 is entry 425, located at file server location 100 and storing the contents of the file B2 in a second location. The entry 407 is then provided with the correct data corresponding to the file B2. The File Location pointer field is set to 1000 and the Sourced By filed is set to the unique User-Pool identifier.

Entry 409 in the file data table 401 includes a User-ID field set to CCC and a File-ID field set to B2. This is the third instance of the file B2 being backed up by a distinct user on the backup storage system. The entry 409 is the fourth entry in the file data table 401 having a File-ID field set to the identifier B2. Thus, the entry 409 includes the File Location pointer field set to 1000, the second location of the contents of the file B2, and the Sourced By field is set to the unique User-Pool identifier. In addition, the Share Count field of the User-Pool entry 411 associated with the second copy of the file B2 is incremented again, to two (2) to show that two users are currently sharing the contents of the file from the user pool.

In this way, any number of users may share the contents of the file B2, or any other file stored in the user pool area without requiring an increase in the number of times that the file B2 is stored on the system. The number of file data table entries will increase by one with each user that wishes to access a file stored in the user pool area. Each new entry will identify the particular user and the particular file and the particular file server location of the file.

As discussed above, many different types of storage media may be used to provide the file backup storage system. For some of these media, access costs and storage costs are such that the costs associated with backing up files makes it more economic to provide files to the User Pool after 3, 4, or even more files have been saved for individual users. It would be obvious to one of skill in the art, therefore, to modify the above described multiple copy file backup system by selecting a threshold number before a second copy of the file is created in the User-Pool to a number greater than two.

Those of ordinary skill in the art should further appreciate that variations to and modification of the above-described methods and systems for providing a multiple copy capability for a network backup system may be made without departing from the inventive concepts disclosed herein. Accordingly, the invention should be viewed as limited solely by the scope spirit of the appended claims.

1. A method for providing multiple copies of backup files on a file backup system, the file backup system storing a plurality of files and a file data table containing a plurality of file data associated with each of the plurality of files, a server coupled to the file backup system and to a client machine, the client machine operated by a user having a user identifier, the method comprising the steps of:
providing by the client machine to the server a file identifier identifying a file to be stored on the file backup system
providing by the client machine to the server the user identifier of the user operating the client machine;
creating a first new entry in the file data table;
setting one of the plurality of file data of the first new entry in the file data table indicative of the file identification to the file identifier provided by the client machine;
setting one of the plurality of file data of the first new entry in the file data table indicative of the user identification to the user identifier provided by the client machine;
detecting, by the server, if the file identified by the file identifier is presently stored on the file backup system;
in the event that a single copy of the file identified by the file identifier is presently stored on the file backup system;
copying the contents of the single copy of the file to a second location within the file backup system;
creating a second new entry in the file data table;
setting one of the plurality of file data of the second new entry in the file data table indicative of the file identification to the file identifier provided by the client machine;
setting one of the plurality of file data of the second new entry in the file data table indicative of the user identification to a user identifier indicative of a user pool;
setting one of the plurality of file data of the second new entry in the file data table indicative of the source by identification to the user pool identifier;
setting one of the plurality of file data of the second new entry in the file data table indicative of the number of users sharing the file contents one;
setting one of the plurality of file data of the first new entry in the file data table indicative of the file location to point to the to the second copy of the file;
setting one of the plurality of file data of the first new entry in the file data table indicative of the sourced by identification to the user pool identifier;
setting one of the plurality of file data of the first new entry in the file data table indicative of the file location to point to the to the second copy of the file.

2. The method of claim 1 further including the steps of:
in the event that the file associated with the file identifier is not presently stored on the backup system,
receiving by the server the file contents from the client,
storing the file on the backup system, and
creating a new entry in the file data table
setting one of the plurality of file data of the new entry in the file data table indicative of the file identification to the file identifier provided by the client machine;
setting one of the plurality of file data of the first new entry in the file data table indicative of the user identification to the user identifier provided by the client machine;
setting one of the plurality of file data of the first new entry in the file data table indicative of the sourced by identification to the user identifier provided by the client machine;
setting one of the plurality of file data of the first new entry in the file data table indicative of the number of users sharing the file contents to zero;
setting one of the plurality of file data of the first new entry in the file data table indicative of the number of users sharing the file contents to zero;
setting one of the plurality of file data of the first new entry in the file data table indicative of the file location to point to the to the second copy of the file.

3. The method of claim 1 further including the steps of:
in the event that two or more copies of the file associated with the file identifier are presently stored on the backup system,
creating a new entry within the file data table associated with the stored file;
setting one of the plurality of file data of the new entry in the file data table indicative of the user identification to the user identifier provided by the client machine;
setting one of the plurality of file data of the new entry in the file data table indicative of the file identification to the file identifier provided by the client machine;
setting one of the plurality of file data of the new entry in the file data table indicative of the source by identification to the user pool identifier;
setting one of the plurality of file data of the new entry in the file data table indicative of the number of users sharing the file contents zero;
finding within the file data table the entry having a user identification and a sourced by identification set to the user pool identifier and having a file identification set to the file identifier received from the client machine;
incrementing the share count of the located file table entry
setting one of the plurality of file data of the first new entry in the file data table indicative of the file location to point to the to the file location contained within the found file table entry.

4. The method of claim 1 further including the steps of:
receiving at the client a user identifier to be cancelled from the file backup system;
finding in the file data table, entries having a user identifier and a sourced by identifier set to the user identifier to be removed;
removing the file contents located at the location pointed to by the file location entry within each of the found file data table entries.

5. The method of claim 1 wherein the step of copying the contents of the single copy of the file to a second location includes copying the contents of the single copy of the file to a second location within the file backup system.

6. The method of claim 1 wherein the step of copying the contents of the single copy of the file to a second location includes copying the contents of the single copy of the file to a new second location within a queue and storing the contents of the single copy of the file to a second location within the file backup system at a later time and setting one of the plurality of file data of the first new entry in the file data table indicative of the file location to point to the to the new second copy of the file.

7. The method of claim 1 further comprising the steps of copying the contents of the file stored at the second location to a third location.

8. A method for providing a multiple copies of backup files on a file backup system, the method comprising the steps of:
making a first copy of a file on the backup system by a first user;
creating a first entry in a file data table at a first location;
associating the first file with the first user as a file source within the first entry;
associating the first file with the first location within the first entry;
requesting to make a second copy of the file by a second user;
making a second copy of the file in a second location;
creating a second entry in a file data table;
associating the second file with a user pool as a file owner and a file source within the second entry;
associating the second file with the second location within the second entry;
creating a third entry in the file data table;
associating the second file with the second user as and identifying the source of the file as the user pool within the third entry; and
associating the second file with the second location within the third entry.
